(19) United States
(12) Patent Application Publication
(10) Pub. No.: US 2004/0241472 A1
(43) Pub. Date: Dec. 2, 2004

(54) Composite material and method for thermoplastic polymer coating

(76) Inventor: Mika Kolari, Espoo (FI)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/482,821

(22) PCT Filed: Jul. 3, 2002
(86) PCT No.: PCT/FI02/00604

(30) Foreign Application Priority Data
Jul. 3, 2001 (FI) 20011451

(51) Int. Cl. H05H 1/26

(52) U.S. Cl. 428/500; 427/446; 264/298

(57) ABSTRACT

The invention relates to a composite material comprising a material to be coated and a coating agent applied to the surface of the material to be coated to form a coating on it. According to the invention, the coating agent of the composite material is a polymer composite material formed from at least one polymer and a filler, which have been melt-mixed together in a desired mixture ratio and the melt mass thus formed has been extruded into a desired form, and the extruded polymer composite material has been thermally sprayed onto the material to be coated to form a coating on it.

The present invention relates to a composite material as defined in the preamble of claim 1, to a method for producing it as defined in the preamble of claim 9 and to a polymer composite as defined in the preamble of claim 19 for use as a coating material on the composite material.

In prior art, various methods for producing different coatings are known. A product or material, e.g. a paper web, textile fabric, cloth or a metallic, wooden or plastic film can be coated with a polymer or plastic layer, thus creating a composite material. A known technique is to form a coating from powdery source materials, which can be applied onto a product or material e.g. by brushing, by spraying or by using an applicator blade.

The problem with prior-art coating methods is the use of powdery source materials and the consequent non-homogeneity of the coating produced. When powdery source materials are used as a coating, it is required that the source materials be thoroughly mixed before the formation and application of the coating, if several source materials or additives are used, in order to achieve a uniform coating. Alternatively, if a material mixture is to be used as coating material, it is necessary to use separate powder supplies. When a coating is produced from powdery source materials by mixing or using separate powder supplies, additional problems result e.g. from the deterioration of the flowability properties of the powder and the separation of constituents due to possible density differences. For example, to allow spraying of polymer coatings based on powdery source materials, the source materials are required to have certain particle and flowability properties, which again means that more additives are needed.

The object of the invention is to eliminate the above-mentioned drawbacks in connection with a composite material and a coating material used as its source material. A specific object of the invention is to disclose a new and improved method for producing a composite material coated with a polymer-based material.

The composite material of the invention, the method of the invention for producing it and its source material are characterized by what is presented in the claims.

The invention is based on an composite material that comprises a material to be coated, i.e. a basic material, and a coating agent, i.e. a coating material applied onto the material to be coated so as to form a coating on it. According to the invention, the coating material used to form a coating on a composite material is a polymer composite material formed from at least one polymer and a filler, which are melt-mixed with each other in a desired mixture ratio, and the melt mass thus produced is extruded into a desired form, e.g. the form of thread or ribbon, and the extruded polymer composite material is thermally sprayed onto the material to be coated, on at least one of its surfaces, to form a coating.

In the present context, “polymer composite material” refers to a very durable multi-component material formed from at least one polymer, one or more fillers and/or possible other additives. “Material to be coated” refers in this context to various materials, such as web-like or sheetlike products, or objects or products of any shape formed from e.g. textile fabric, paper, cardboard, cloth, metal, wood, plastic or equivalent.

In an embodiment of the invention, the polymer composite material is extruded into the form of a thread or ribbon.

In an embodiment of the invention, the polymer or polymers of the polymer composite material are thermoplastic polymers. The thermoplastic polymer may be e.g. one of PE, PP, PA or PVC according to selection.

In an embodiment of the invention, the filler of the polymer composite material is a material or material combination capable of withstanding melt mixing and thermal treatment, e.g. spraying. In an embodiment, the filler is a ceramic and/or metallic filler material.

In an embodiment of the invention, the amount and/or mixture ratio of polymer and filler in the polymer composite material is/are precisely defined in order to form a polymer composite material having desired properties. In an embodiment, the percentage of filler in the polymer composite material is 10-0.30% by volume, preferably 10-20% by volume.

In an embodiment of the invention, the polymer composite material contains a reinforcing substance and/or various other additives.

The quantity and quality of the polymer, filler, reinforcing substance and/or additives of the polymer composite material are preferably adjusted so as to achieve a composite material having desired properties.

In the method of the invention for producing a composite material, the material to be coated is coated with a coating agent. According to the invention, the coating agent used is a polymer composite material formed by melt-mixing at least one polymer and a filler together in a desired mixture ratio and extruding the melt mass thus produced into a desired form, and the extruded polymer composite material is thermally sprayed onto the material to be coated, on at least one of its surfaces, to form a coating on the composite material.

In a preferred embodiment, in the extrusion of the polymer composite material, a continuous polymer web is produced using a mainly powdery or granular plastic mass and a filler as source materials. The plastic mass and the filler are fed into an extruder, which may be basically a single-screw or double-screw device, in which the plastic mass is mixed, melted, homogenized and extruded as a product of desired form, usually by means of a drawing device.

In an embodiment of the invention, the polymer composite material used as a coating agent is thermally sprayed onto the surface of the material to be coated substantially directly after extrusion. In an alternative embodiment, the polymer composite material is thermally sprayed onto the surface of the material to be coated in a substantially separate process after a time interval, e.g. after a desired period of storage of the polymer composite material.

According to the invention, a polymer composite material formed from at least one polymer and a filler by mixing them together in a desired mixture ratio and extruding into a desired form is used as a source material for forming a thermally sprayed, polymer-based coating on a composite material by thermally spraying the polymer composite material onto the surface of the desired material to be coated.

The invention makes it possible to solve the problems associated with the traditional method of forming a coating on a composite material, based on the use of powdery source materials; by applying the invention, a uniform and homogeneous coating is produced on the composite material. The coating agent, i.e. the polymer composite material of the invention can be produced separately e.g. so that it contains an advantageous combination of different components, such as polymers, fillers and/or additives. Thus, in the manufacture of the composite material, no separate mixture is needed for forming a coating agent and a coating; instead, the coating agent, i.e. the polymer composite material in itself contains suitable and desired constituents and is ready for use for coating. The polymer composite material, e.g. in a thread-like or ribbon-like form, simplifies the supply of source materials in thermal spraying of multi-component coatings. Moreover, the process of spraying a coating agent onto a composite material is made easier and faster.

The invention allows considerably easier optimization of the composition of the coating mixture than prior-art methods and materials, permitting an optimal coating to be produced for the desired purpose. The polymer composite material of the invention can be used in the manufacture of various polymer based coatings. The properties of the coatings can be easily changed by varying the quality and/or quantity of the polymer and/or filler and/or other additives used in the polymer composite material. Via the choice of filler, it is possible to influence e.g. the thermal conductivity or wear resistance of the filler, which considerably increases the possibilities of using sprayed polymer coatings in different industrial applications. An advantageous industrial application is e.g. corrosion protection in process industry.

The method of the invention has the advantage of being simple and easy to implement.

In the following, the invention will be described by the aid of detailed examples of its embodiments.

### EXAMPLE 1

### Producing a Polymer Composite Material

Laboratory experiments were carried out to investigate the production of a polymer composite material by using a double-screw extruder known in itself.

The polymer used in the experiments was the thermoplastic PA 11 polymer, which is well applicable for extrusion. As a filler, three different alternatives were used:

1. Boric nitride, particle size about 60 μm

2. Zinc dioxide, particle size about 0.3 μm

3. Talcum, particle size about 30 μm.

The polymer and the filler, with a mixture ratio of 80/20. % by volume, were fed into a double-screw extruder, where they were melt-mixed together to form a homogeneous mass. The blended melt mass was extruded through nozzles with small apertures at a suitable speed by drawing it into a thread-like form using a drawing device comprised in the apparatus.

In all the above-mentioned experiments 1-3, polymer composite thread having properties suited for use in the formation of a coating on a composite material was obtained.

It was established in the experiments that the high limit of filler content is determined e.g. by the moistening between polymer and filler and the specific area of the filler. Via the filler and its concentration, it is possible to adjust the properties of the polymer composite thread and the coating produced from it, e.g. its thermal conductivity, friction, combustion, fire resistance and/or wear or equivalent. It was discovered that when the filler content varies within the range of about 10-20% by volume, material properties advantageous for the coating of a composite material are achieved in the polymer composite material.

### EXAMPLE 2

### Producing a Composite Material

This experiment was carried out to determine the applicability of polymer composite threads formed according to example 1 for the formation of a thermally sprayed coating on a composite material.

The coating material, i.e. e.g. polymer composite thread according to example. 1 was thermally sprayed as a thin web at a suitable temperature onto one of the flat surfaces of a web of material, i.e. sheet steel to be coated, covering it uniformly.

Thermal spraying of a coating material is in itself a fully known technique in the industry, so it will not be described here in detail.

In the experiment, it was established that the above-described polymer composite threads are excellently applicable for forming a multi-component coating on a composite material by the thermal spraying technique; a uniform, homogeneous and durable coating was achieved.

In an embodiment of the method, the polymer and the filler can be dried before being fed into a double-screw extruder.

The polymer selected for use in the method may be any known thermoplastic polymer, and similarly the filler selected may be any material or material combination that is capable of withstanding melt-mixing and thermal spraying. In addition, the manufacture of the polymer composite material can be implemented using suitable additives, depending on the application in which the coating formed from the polymer composite material is to be used.

The composite material of the invention is applicable in different embodiments for the formation of different products. The method of the invention for the manufacture of composite materials is applicable for use in the manufacture of various composite materials according to the invention. Furthermore, the polymer composite material of the invention is applicable for use as a source material for forming different coatings on a composite material.

The embodiments of the invention are not limited to the examples presented above; instead, they may be varied within the scope of the following claims.

1. Composite material comprising a material to be coated and a coating agent applied by a thermal spraying technique to the surface of the material to be coated so as to form a coating on it, characterized in that the coating agent of the composite material is a polymer composite material formed from at least one desired thermoplastic polymer and a filler so that the mixture ratio of polymer and filler is precisely defined, the filler content being 10-20% by volume, to achieve an optimal coating composition for the composite material, and the polymer and the filler have been melt-mixed together and the melt mass thus formed has been extruded into a desired form.

2. Composite material according to claim 1, characterized in that the polymer composite material has been extruded into the form of a thread or ribbon.

3. Composite material according to claim 1, characterized in that the filler of the polymer composite material is a material or material combination capable of withstanding melt mixing and thermal treatment.

4. Composite material according to claim 1, characterized in that the filler of the polymer composite material is a ceramic and/or metallic filler material.

5. Composite material according to claim 1, characterized in that the amount of polymer and filler in the polymer composite material is precisely defined.

6. Composite material according to claim 1, characterized in that the polymer composite material contains a reinforcing substance and/or other additives.

7. Method for producing a composite material so that the material to be coated is coated with a coating agent which is thermally sprayed on to the surface of the material to be coated so as to form a coating on it, characterized in that the coating agent used for coating the composite material is a polymer composite material which is formed by accurately adjusting the mixture ratio of at least one desired thermoplastic polymer and a filler, the filler content being in the range of 10-20% by volume, to achieve an optimal coating composition for the composite material, and melt-mixing the polymer and the filler together and extruding the melt mass thus formed into a desired form, to be used as coating agent.

8. Method according to claim 7, characterized in that the polymer composite material is extruded into the form of a thread or ribbon.

9. Method according to claim 7, characterized in that the coating of the material to be coated is performed substantially directly after the extrusion of the polymer composite material.

10. Method according to claim 7, characterized in that the coating of the material to be coated is performed substantially as a separate process.

11. Method according to claim 7, characterized in that the filler used in the polymer composite material is a material or material combination capable of withstanding melt-mixing and thermal treatment.

12. Method according to claim 7, characterized in that the filler used in the polymer composite material is ceramic and/or metallic filler material.

13. Method according to claim 7, characterized in that the amount of polymer and filler in the polymer composite material is adjusted so as to achieve a polymer composite material having exactly the desired properties.

14. Method according to claim 7, characterized in that the polymer and the filler of the polymer composite material are melt-mixed in a double-screw extruder.

15. Polymer composite material for use as a source material for forming a polymer-based coating on a composite material, characterized in that the polymer composite material has been formed from at least one desired thermoplastic polymer and a filler so that the mixture ratio of polymer and filler is accurately defined, the filler content being 10-20% by volume, to achieve an optimal combination of material properties, and the polymer and the filler have been melt-mixed together and the melt mass thus formed has been extruded into a desired form, and the extruded polymer composite material is thermally sprayable onto the surface of a material to be coated to form the coating of the composite material.

16. Composite material according to claim 2, characterized in that the filler of the polymer composite material is a material or material combination capable of withstanding melt mixing and thermal treatment.

17. Method according to claim 8, characterized in that the coating of the material to be coated is performed substantially directly after the extrusion of the polymer composite material.

18. Method according to claim 8, characterized in that the coating of the material to be coated is performed substantially as a separate process.
